(19) United States
(12) Patent Application Publication
(10) Pub. No.: US 2002/0058232 A1
(43) Pub. Date: May 16, 2002

(54) Method for root canal treatment: technique, tools and materials for mobilizing medicaments and cements into dentinal tubules

(76) Inventors: Ervin I. Weiss, Herzeliya (IL); Zvi Fuss, Tel-Aviv (IL); Levi-Shaoul Assouline, Kiriyat-Bialick (IL); Amir Mizrahi, Kfar-Saba (IL)

Correspondence Address: Sol Sheinbein, G E Ehrlich (1995) Ltd, 2001Jefferson Davis Highway, Suite 207, Arlington, VA, 20231, US

(21) Appl. No.: 09/800,696

(22) Filed: Mar. 7, 2001

Related U.S. Application Data
(63) Continuation-in-part of application No. 09/669,065, filed on Sep. 22, 2000.

(51) Int. Cl. A61C 5/02; A61C 3/00

(52) U.S. Cl. 433/224; 433/32; 433/102

(57) ABSTRACT

There is provided a method of dental treatment by preparing the space in need of treatment and further mobilizing products into otherwise inaccessible space in need of treatment. Also provided is a tool for dental treatments including a mobilizer for actively moving a product from a deposit site to an oral treatment site.

### CROSS-REFERENCE TO RELATED APPLICATION

This is a Continuation-In-Part Application of U.S. patent application Ser. No. 09/669,065, filed Sep. 22, 2000, which is incorporated herein by reference.

### BACKGROUND OF THE INVENTION

1. Field of the Invention

The present invention relates to a method of root canal treatment. More specifically, the present invention relates to tools and techniques for mobilizing medicaments for root canal treatment.

2. Description of Related Art

Root canal treatment is necessary whenever the tissues in root canals are injured and/or infected. Bacteria and their products that have destroyed the pulp (soft tissue which occupies the inner space of the teeth) can leak out of the root into the surrounding bone, which reacts in bone resorption occupied by inflammatory (granulation) tissue (FIG. 1A). The purpose of the treatment is to remove possible etiological factors, i.e. bacteria and organic matter, from the root canal (FIG. 1B) and to fill the space in order to prevent bacterial invasion and irritation to the periapical tissues allowing the host defense and repair mechanisms to correct the damages.

The dentinal wall of the root is comprised of calcified organic matrix through which ca. 30,000 tubules/mm² are passing horizontally from the root canal space towards the outer surface of the root (FIG. 3). The dentinal tubules have a diameter of ca. 2-5 micrometer and are filled with organic matter. The tubular structures allow for bacteria to penetrate, survive and even proliferate in these micro niches.

Treatment complication or failures occur when infecting bacteria are not eliminated completely from the root canal space and/or the dentinal tubules. Bacterial invasion of microscopic spaces in the root dentin, such as dentinal tubules, (FIG. 3) irregularities or imperfections in the dentin structure including isthmuses, ramifications, accessory canals and apical deltas (FIG. 2), can further complicate the root canal treatment and its outcome.

Bacteria are commonly detected in the root canal systems despite conventional mechanical preparation (Kakehashi et al 1965). It was shown that the number of bacteria, which survived instrumentation (mechanical preparation) and irrigation during root canal treatment, increased rapidly in between treatment appointments (Bystrom and Sundqvist 1981, 1985). A variety of intracanal medicaments are used in an attempt to eliminate these bacteria and to further disinfect the root canal dentinal walls. In vitro tests showed that bacteria are killed only when they are in direct contact with commonly used medicaments such as calcium hydroxide or Ledermix (Spangberg 1982). However, these materials have limited ability to penetrate into and disinfect the dentinal tubules (Haapasalo and Orstavik 1987, Sigueira and Uzeda 1996).

A long-term study (Sjogren et al 1990) revealed a 14% failure rate when endodontic treatment was performed with gutta-percha (most commonly used filling material in root canal therapy) and cement in teeth with periapical lesions (such as shown in FIG. 1A). This could be due to both insufficient debridment of the root canal space during treatment and inadequate root canal seal. Sjogren et al (1990) found significant correlation between the quality of the seal and success rate when previously root-filled teeth with periapical lesions were treated.

All root canals treated and filled are leaking (Gutmann 1992). A complete seal of the root system is impossible with currently accepted materials and obturation techniques (Gutmann 1993). Different techniques of gutta percha delivery and a multiplicity of sealers have all shown varying degrees of sealing ability. The pattern of fluid and microorganism flow provides a constant source of nutrients and newly evading microorganisms that maintains and/or initiates periradicular inflammation (Saunders and Saunders 1994).

It is now widely accepted that bacteria invading dentinal tubules, root canal ramifications, isthmuses, and apical deltas are responsible for persistent endodontic infections (Akpata and Blechman 1982). Coronal leakage is responsible for persistent endodontic infections. (Akpata and Blechman 1982). Coronal leakage is an additional route for bacterial ingress in treated root canals, sealed with gutta percha and sealer, leading to failures (Swanson and Madison 1987).

Currently, removal of the etiologic factor(s) can be performed by a number of methods. First, mechanical instrumentation can be used for the removal of the contaminated dentin from the inner walls of the root canal space. A limitation however is that thorough and/or extensive mechanical preparation might weaken the tooth root leading to possible cracks and fractures (observed often clinically). Additionally, mechanical instrumentation cannot treat or affect efficiently infected isthmuses, ramifications, accessory canals and deltas (FIG. 2).

A second method involves the introduction and penetration of antibacterial materials into the dentinal tubules to kill bacteria. Nonetheless, all known materials possess limited penetration ability into dentinal tubules (or other irregularities) thus limiting their effectiveness.

In the past, various medicaments have been used to disinfect the root canal space. Attempts were made with different techniques to introduce the antibacterial agents into the dentinal tubules, using evaporating and toxic elements. As yet, no material or technique could penetrate efficiently and kill bacteria in the dentinal tubules. (Haapasalo, Orstavik 1987)

For example, U.S. Pat. No. 4,886,075, to Jones, discloses a thermoelectric antibacterial ion-generating device comprised of a needle, which fits into root canals of teeth that are undergoing endodontic therapy. A field of positive silver ions is generated and focused on the root apex area for killing bacteria that are in the infected bone area around an abscessed tooth. This method utilizes metallic ions. In addition, the ion generator provides a positive voltage which stimulates healing and osteogenesis.

The Jones method functions by creating an “electric current” generated by thermoelectro junction formed by two metals both inserted into the root canal space. Then metallic ion (silver ions) are generated, which are potentially toxic, these ions are the effectors for antibacterial activity. The disclosed effect pertains to the periodontal membrane and bone surrounding the tooth. However, there is no disclosed effect on bacteria, which invade the dentinal tubules, isthumses, ramifications and or deltas. Further, as shown by FIG. 1A of the Jones patent, the electric current flows out through the apex of the root canal. Thus, the method of the Jones patent never treats the most problematic area, namely the dentinal tubules.

Another example of a proposed treatment is set forth in the prior art which discloses the use of a resorcin formalin mixture, having a toxic effect (SU Patent Number 1806683). The material is introduced into the root canal and the electrode of a diathermal coaggulator generates electric current resulting in heat. This evaporates the resorcin formalin mixture and the vapors diffuse into the dentinal tubules. However, the heat generated can cause damage to soft and hard tissues. Additionally, since the apex of the root canal is not blocked to prevent the escape of electric current, this procedure actually moves treatment away, not to, the problematic area.

Further, Russian Patent No. 2008841 discloses the treatment of the vital amputation of the pulp (e.g. the content of the root canal is vital (limited bacterial invasion)) and the surrounding dentinal tubules which contain the processes of viable odontoblastic cells. This condition does not allow bacterial penetration and invasion. The patent relates to root canal filling material under vacuum, which contacts the amputated vital pulp stump.

Additionally, another SU Patent No. 1775394A discloses a ferroelectrically active ceramic (piezoelectric) element connected to needle electrodes inserted into the root canal space. The vibration created by the piezoelectric element introduces the medicament into the root canals. A similar method is disclosed in SU Patent No. 869773E uses a magnetic field as the driving force for introducing the materials or medicaments into the root canal space.

In the method described by A Knappwost (A Knappwost 1993) of the Leodent Export-Import Company of Bremen, Germany, there is no suggestion for a primary mechanical preparation of the apicel portion of the canal prior to treatment. Thus, the method requires two to three visits rather than one. Furthermore, Knappwost's method requires toxic elements, such as copper in the medicament in order to disinfect the unprepared root canals. Knappwost's method uses electrodes which are not introduced all the way to the root end (apex) and therefore its effectiveness at the most needed area is limited. In addition the electrode is not coated with insulating material and thus has no control on the electric field. For example, the electrode, which is introduced into the root canal can touch the dentin creating a short circuit and the current can be directed to the least resistance area rather to the needed one. Further, as with previous methods there is no seal or insulation placed at the apex of the root canal. Therefore, the materials (driven by electric current) which are intended to treat the root canal may flow out through the apex without ever reaching the most problematic areas of the root canal, namely the dentinal tubules.

It would therefore be useful to create a method and tool for the application of intercanal medication which:

1. mobilizes medicaments and other materials to desired target

2. does not include a potentially toxic chemical and

b 3. without requiring multiple visits at the dental office (for the patient).

### SUMMARY OF THE INVENTION

According to the present invention, there is provided a method of dental treatment by preparing the space in need of treatment and mobilizing products into the space in need of treatment. Also provided is a tool for dental treatment including a mobilizer for actively moving a product from a deposit site to an oral treatment site.

### DESCRIPTION OF THE DRAWINGS

Other advantages of the present invention will be readily appreciated as the same becomes better understood by reference to the following detailed description when considered in connection with the accompanying drawings wherein:

FIG. 1A and B are pictures depicting the prepared root canal space;

FIG. 2 is a picture depicting the isthumses, ramifications, accessory canals and apical deltas;

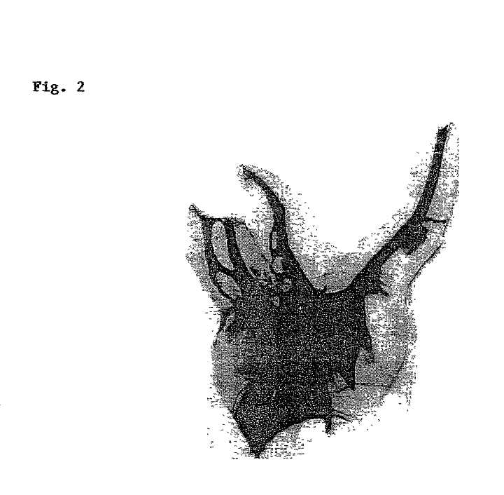

FIG. 3 is a picture depicting the cross section of the root;

FIGS. 4(A), (B) and (C) are pictures of the specially designed electrodes for use with the present application;

FIG. 5 is a graph showing colony forming units versus distance from root canal;

control=infected root canal without Ca(OH)₂ no electric current

CH=infected root canal with Ca(OH)₂ no electric current

current+=infected root canal with Ca(OH)₂ and electric current

curent++=infected root canal with Ca(OH)₂ and electric current applied twice.

FIG. 6 is a graph showing the pH of root dentin both with and without electric current.

### DETAILED DESCRIPTION OF THE INVENTION

Generally, the present invention provides a method and tool for dental treatments including a mobilizer for actively moving the product into the space in need of treatment from the deposit site.

By way of definition, the preparation is defined in the application to mean removing the undesirable material from the space in need of treatment. This can include, but is not limited to, mechanical tools, and other such tools known by those of skill in the art.

The term “mobilizer” is defined in the application to mean a tool which is capable of actively moving molecules of the desired product into the space in need of treatment. That is, medicament is not merely disposed proximal to an area of treatment expecting diffusion or any other passive mechanism to move the medicament or other product for treatment to the site of treatment. Rather, the mobilizer or mobilizing means actively moves the product to the site of treatment. Preferably, this is accomplished by a device which creates an electric potential or current for moving product from an application site to the site of treatment and preferably only to the site of treatment. This can include but is not limited to electrodes and other tools known to those of skill in the art.

The purpose of root canal treatment is to remove microorganisms and organic matter from the root canal and to fill the space in order to prevent bacterial irritation to the surrounding tissues. Bacteria invading dentinal tubules, root canal ramifications, isthmuses, and apical deltas are responsible for persistent endodontic infections. With the conventional state of the art root canal treatment, bacteria elimination, is based mainly on thorough mechanical preparation and irrigation of the root canal space.

The present invention instead focuses on the introduction of product. The term “product” includes, but is not limited to, antibacterial materials, antibiotics, therapeutic materials and sealing materials. Such products are mobilized into the conventionally prepared root canal space and into dentinal tubules, isthmuses, ramifications, accessory canals, deltas and other difficult sites which are otherwise inaccessible to these products in conventional treatment. These products are mobilized via an electric field created using a unique electrode inserted into the root canal space (the intra canal electrode) while a second electrode is located outside the tooth e.g. connected to the oral mucosa. The intra canal electrode can be selectively coated with insulating material to direct the electric current to specific and/or limited areas along the internal part of the tooth said root canal space comprising of the root canal space and pulp chamber.

The present invention uses materials, tools, and techniques for (i) intracanal medication, (ii) obturation of root canal, (iii) tooth restorations and (iiii) root surface desensitization. These materials, tools, and techniques dramatically improve to the overall success of root canal treatment by having the following advantages. 1. This method kills bacteria from root canal areas, which are inaccessible to mechanical and conventional chemical preparations such as dentinal tubules, ramifications, isthmuses, and apical deltas; 2. The treatment is short, safe, non-invasive and does not use toxic elements; 3. It adds to the concept of conservative treatment because it does not require extensive removal of tooth substance, which may compromise the resistance to mechanical cracks and breakage; 4. The present method allows the successful completion of root canal treatment in a single visit at the dentist; 5. Using the present technology, sealing materials (currently available or specially developed) can be driven into the tubules by the electric field; this can minimize the coronal to apical leakage by improving the sealing of the dentinal tubules facing the root canal space; this can also provide a barrier against bacterial reinfection and invasion; and 6. The method has potential use in other areas of dentistry.

Antibacterial components can be introduced in dentinal tubules containing bacteria and living odontoblast. This can be used for attraumatic restorative treatment (ART) (van Amerongen and Rahimtoola 1999). Therefore, restorative materials can be driven into dentinal tubules improving both retention and seal. Accordingly, sensitive teeth can be desensitized by applying sealing materials onto exposed root and dentin surfaces.

The present invention uses products, tools, and techniques for root canal treatment. These include but are not limited to, intracanal medication and obturation of root canals. In addition the invention can be used for root surface desensitization and in novel approaches for tooth restorations such as in atraumatic restorative treatment (ART).

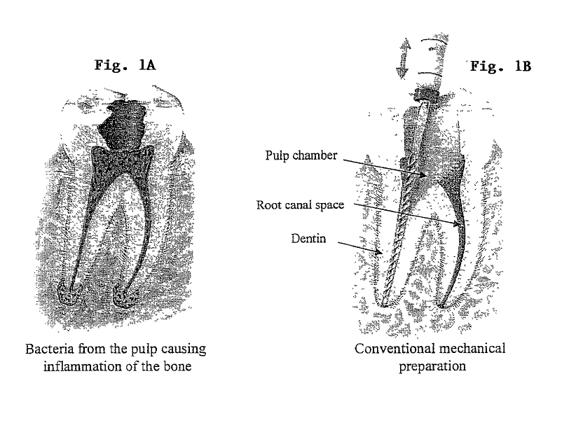

The present invention provides a method of introducing antibacterial materials, antibiotics, therapeutic materials and sealing materials into the conventionally prepared root canal space (shown in FIG. 1B) and mobilizing the products into dentinal tubules, isthmuses, ramifications, accessory canals and deltas which are inaccessible to these materials in conventional treatment. According to the present invention, the root canal space is prepared mechanically by state of the art methods, for example, using nickel titanium rotary instruments (Lightspeed®) to recommend sizes as listed in Table 1. The apex of the tooth is then insulated or otherwise prepared in such a way as to prevent the escape of current from the area to be treated. Insulation can be obtained by the selectively coated/insulated intracanal electrodes. Examples for insulating materials are silicon, rubber, gutta percha, wax, Teflon. If the area is not insulated, the electric current will escape and the product will not be delivered to the sites in need of treatment, because the resistance into the site of treatment is greater than the resistance of escaping from the area of treatment. It is possible that passing materials, medicaments or therapeutic agents, beyond the root apex is needed. In this situation the root will be treated twice.

a. With the apex insulated as above;

b. With non insulated apex.

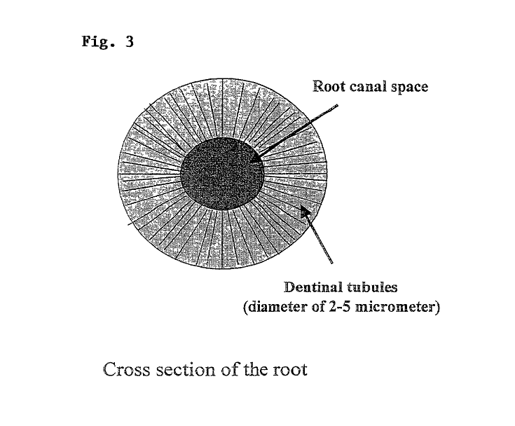

The products are introduced in the root canal space and mobilized via a low current electric field created using a specially designed electrode (examples are shown in FIG. 3A, B and C) inserted into the root canal space while another electrode is located outside the tooth e.g. connected to the oral mucosa.

The products are mobilized into the treatment space because the molecules of these products are electrically charged. Therefore, with the administration of an electric current, and proper placement of the electrodes, the molecules will move to the desired treatment site. These molecules will move at different rates of speed dependent upon their charge and size. Therefore, different molecules can be placed into the treatment site at a single time while still enabling multiple treatments of one site. Since there is a different rate of movement for the different molecules, a chromatographic effect is created, which allows for the use of multiple products in a single treatment.

The intra canal electrode can be selectively coated with insulating material to direct the electrophoretic current to specific and limited areas along the internal part of the tooth's root canal space including of the root canal space and pulp chamber. The uncoated (non-insulated) area on the electrode is facing the region in the root canal space and/or pulp chamber that needs treatment into which the therapeutic/antibacterial/sealer is to be introduced.

The current is controlled in such a way that the system should not generate excessive heat and temperature of the tooth is not raised above 40/7C. Preferably a maximum of five milliamps is utilized. Alternatively, a pulsing current can also be used. This prevents a build up of heat in the area of treatment and increases the effectiveness of the treatment.

The present invention is a combination of an electronic device, special electrodes and antibacterial agents with no known side effects or toxic elements. The electronic device using low voltage low current is able to electrically mobilize the antibacterial agent deep into the dentinal tubules at least up to 0.6 mm and kill within short time (seconds to minutes) all bacteria. This bacterial free dentin is 3-4 times wider and beyond the depth of dentin removed by the recommended mechanical preparation (which is in the range of 0.15-0.2 mm; Table 1) and is coming in addition to the mechanical preparation rather than replacing it.

The method of the present invention can be used for other applications besides treatment of the root canal space. For example, this method can be used for atraumatic restorative treatment (ART), or filling cavities. When the method is used for filling cavities, the decayed material is removed mechanically or by any other means known to those of skill in the art. The product is placed on the tooth and mobilized into the dentinal tubules. A sufficient amount of product is utilized to kill any remaining bacteria. Then a sealer is mobilized into the dentinal tubules to prevent further decay. By forcing the sealing product into the tubules in this manner, the dentist is ensured a tight seal with the tooth.

The method of the present invention can be used for treating root surface sensitivity. Root surface sensitivity occurs when the gum recedes leaving the root exposed. Previously, the treatment involved merely superficial covering the surface with a high salt content sealer or with resin based sealer. The problems associated with this are that the seal is superficial and can be accidentally removed by tooth brushing. However, using the method of the present invention, the sealer product is applied and forced deep into the tubules, providing a long lasting and sufficiently tight seal for preventing further problems.

Additionally, problems have arisen with regard to implant failures, for both dental and orthopedic implants. Previously, the only solution was to remove the implant. Now, utilizing the method of the present invention, all that is required is to mobilize an antibacterial compound into the biofilm of the implant and then wait for healing to occur. After healing has occurred, additional therapeutic compounds can be mobilized using the method of the present invention, thus providing a preventive treatment to avoid future implant failure.

The above discussion provides a factual basis for the use of the method and materials for dental treatment. The methods used with and the utility of the present invention can be shown by the following non-limiting examples and accompanying figures.

### EXAMPLES

### Example 1

The in vitro model for dentinal tubule infection of root canals originally described by Haapasalo and Orstavik (1987) was used in the present invention with some modifications. Extracted, intact bovine incisors were kept in 0.5% NaOCl overnight for surface disinfection. The apical 5 mm and two-thirds of the crown were removed with a rotary diamond saw at 1000 rpm (Isomet plus precision saw, Buehler, Ill. U.S.A.) under cooling water. The root canal of the center piece was enlarged to 2 mm in diameter with a reamer bur (Zipperer, Munich Germany). The cementum was removed using a polish paper (Ecomet 3, variable speed grinder-polisher, Buehler Ill. U.S.A.) under cooling water, resulting in a center-holed root dentin piece of ca. 6 mm outer diameter. The root was then cut into slices of 4 mm thick with a diamond saw as above. The canals of the 4 mm blocks were enlarged with an ISO 023 round bur using a slow speed dental contrangle handpiece. All teeth and dentin slices were kept in vials containing tap water during all procedures to avoid dehydration. Sterilization was conducted by autoclaving the specimens in the vials for 15 minutes at 121/7C. Six specimens serving as negative control were incubated in growth media at 37/7C for 48 hours to confirm sterilization.

A total of 24 sterile specimens were divided to four groups. Each of the 24 specimens were transferred to a separate test tubes containing 1.5 ml brain heart infusion broth 37 g/liter H₂O (Difco, Detroit, Mich., U.S.A.) inoculated with the test microorganism. This medium was changed every two days for 21 days.

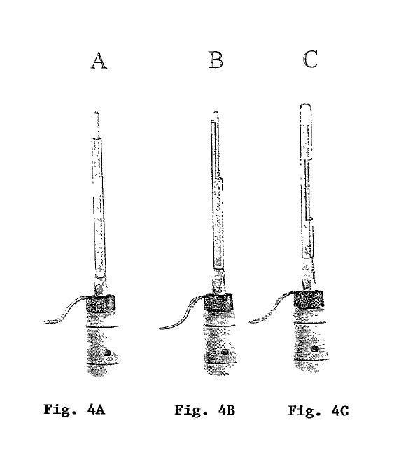

Enterococcus faecalis, a common isolate from infected root canals (Sundqvist 1992) was used in numerous studies of antibacterial properties because of its relative resistance (Haapasalo & Orstavik 1987). In the present invention, a clinical isolate of E. faecalis T2, which was selected to be resistant to 2 mg ml-1 streptomycin (Weiss et al 1996, Shalhav et al 1997, Fuss et al 1997), was used. Streptomycin sulfate, at a concentration of 0.5 mg/ml, was included in all test tubes including the controls to overcome possible contamination in the experimental setup (Weiss et al. 1996). Calcium hydroxide [Ca(OH)₂] in an aqueous paste was introduced into the root canal space of the experimental specimens. In groups 1 and 2 (6 specimens/group), ions derived from Ca(OH)₂ were mobilized via a low current electric field created using an electrode (FIG. 4A, B and C) which was inserted into the root canal space while another electrode is located outside the specimen. Group 1 received a current of 5 miliampers per 5 minutes while Group 2 received two sets of similar current. In Group 3 the Ca(OH)₂ was left for a week without receiving any current. Group 4 served as control without Ca(OH)₂.

At the end of the experiment period, dentinal samples were taken from each test specimen with sterile round burs mounted in a handpiece and run at low speed. The specimens were kept in place with sterile forceps during the sampling and the burs were used in sequence in the following ISO sizes: 025, 027, 029 and 031. Prior to sampling, the coronal and apical surfaces of each specimen were gently curreted to prevent possible remnants of bacteria. Each bur removed a dentinal layer from the inner surface of the canal in the shape of a hollow cylinder 100 μm thick with increasing radius as burs were changed. The dentin chips obtained with each bur were immediately collected in separate test tubes containing 1 ml of brain-heart infusion broth and streptomycin The tubes were vigorously mixed by vortex and incubated for one hour at 37° C. with agitation. Then, the content of each test tube was serially diluted (10×) and triplicate samples of 0.01 ml were spread on brain heart infusion agar plates. These plates were incubated for 24-48 hours at 37° C. Growing colonies were counted and recorded as colony forming units (cfu). For each dentinal layer at least triplicate samples from two agar plates were counted.

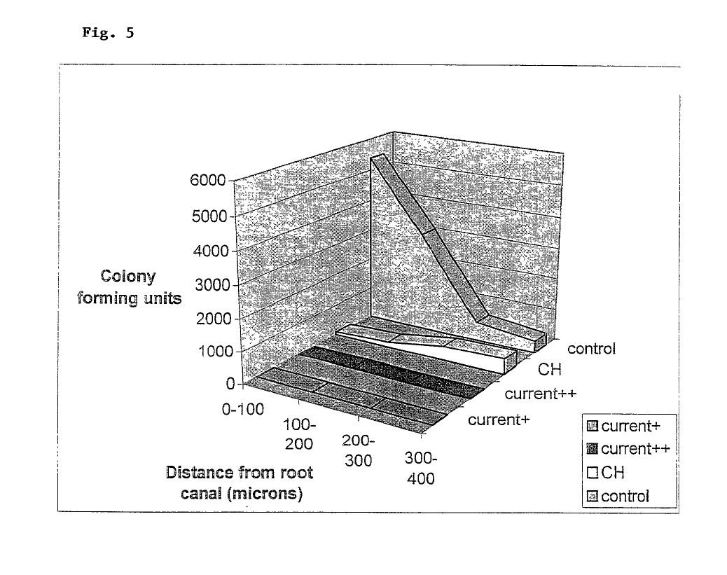

The cfu represents a close estimate of viable bacteria penetrated into dentinal tubules at different layer depths. The numbers of cfu obtained from 4 consecutive dentinal layers are presented in FIG. 5. In the control specimens heavy bacterial infection was observed at the layer close to the lumen. This decreased rapidly from layer to layer up to the deepest layer tested (400μm) which contained several hundred of cfu. Ca(OH)₂, without electric current, reduced the amount of viable bacteria in the first and second layers, but did not eliminate them completely. However, in the third and fourth layers Ca(OH)₂ had no effect on bacterial viability. The application of low electric current using the method and the elements in the present invention completely eliminated bacterial survival in the dentinal tubules at least up to 400 μm from the root canal lumen. Therefore, bacteria can be affected and even effectively killed at a distance of more than 400 μm from the dentin outer surface by using the method of the present invention.

### Example 2

For calcium hydroxide to act effectively as an intracanal dressing, the hydroxyl ions must diffuse through dentin tubules. Hydroxyl ions diffusion can be measured by measuring the pH of dentin at the outer root surface. (A. Nerwich, et al 1993).

Twelve extracted human permanent teeth with single canals were divided in two groups; experimental and control. Teeth were stored in unbuffered saline solution containing 0.05% sodium azide until used. All root canals were cleaned and shaped to a size 40 master file 1 mm from the anatomical apex. Irrigation during cleaning and shaping was carried out with 2.5% NaOCl. The canals were flushed with 1 ml of 17% EDTA which was left in place for one minute to remove the smear layer followed by a final irrigation with 5 ml of sodium hypochlorite. Cavities were drilled in the outer root surfaces of all teeth at midway between the cement enamel junction and the root apex. The cavities, 1.75 mm diameter, were cut to an approximal depth of 1.0 mm from the root canal space. Root canal spaces of all teeth were filled by injecting an aqueous suspension of calcium hydroxide [Ca(OH)₂] pH 12.5. In six teeth OH⁻ ions were mobilized via, a low current electric field, 10 miliampers per five minutes, created using an electrode inserted in the root canal space while another electrode was located outside the specimen. The other six teeth served as control without electric current. The pH in the cavities drilled in the dentin was determined using a pH microelectrode (model Ml 4152. Microelectrodes Inc., Londonderry, N.H.). The pH measurements were performed within two minutes after the current application.

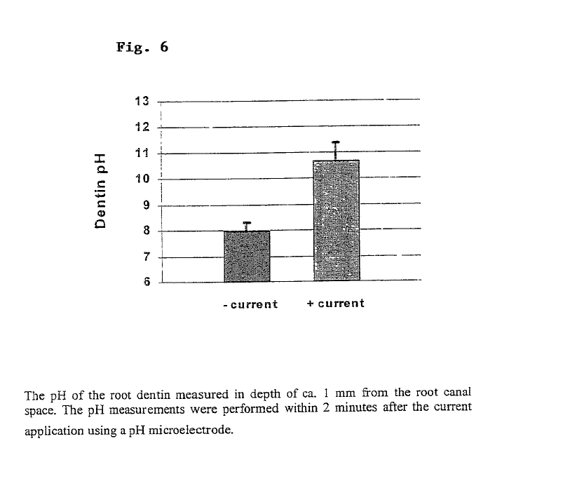

Results are shown in FIG. 6. In the control group, pH of the root dentin measured in depth of ca. 1 mm from the root canal space was 8.0. FIG. 6 shows the pH of the root dentin measured in depth of ca. 1 mm from the root canal space. These values are in good agreement with the results of Nerwich et al. (1993). However, in the experimental group with the electric currents a significantly higher pH was measured ; an average of 10.6 pH.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

TABLE 1
Average sizes (diameter in 1/100 mm) of nickel titanium rotary
instruments Lightspeed negotiated the apical (tip of the root)
third of the root canal before and after instrumentation.
It is the difference in the diameter of the root canal space before
and after insnstrumentation that contribute significantly to
the success of the endodontic treatment.

| | | Before | After |
|---|---|---|---|
| | canal | instrumentation | instrumentation |
| Maxilla | central 1 | 45 | 70 |
| | lateral | 35 | 60 |
| | cuspid | 35 | 60 |
| | 1^{st} premolar | 35 | 60 |
| | 2^{nd} premolar | 30 | 50 |
| | 1^{st} molar B | 25 | 40 |
| | 1^{st} molar P | 30 | 50 |
| | 2^{nd} molar B | 25 | 40 |
| | 2^{nd} molar P | 30 | 50 |
| Mandible | central 1 | 30 | 60 |
| | lateral | 30 | 60 |
| | cuspid | 30 | 55 |
| | 1^{st} premolar | 30 | 55 |
| | 2^{nd} premolar | 30 | 55 |
| | 1^{st} molar B | 25 | 40 |
| | 1^{st} molar D | 30 | 50 |
| | 2^{nd} molar B | 25 | 45 |
| | 2^{nd} molar D | 30 | 50 |

### References

Akpata E S, Blechman H. Bacterial invasion of pulpal dentin wall in vitro. J Dent Res 1982;61:435-8

Bystrom A, Sundqvist G. Bacteriologic evaluation of the efficacy of mechanical root canal instrumentation in endodontic therapy. Scand. J. Dent. Res. 1981 ;89:321-8.

Bystrom A, Sundqvist G. The antibacterial action of sodium hypochlorite an EDTA in 60 cases of endodontic therapy. Int Endod J 1985;18:35-40.

Bystrom A, Sundqvist G. Bacteriologic evaluation of the effect 0.5 per cent sodium hypochlorite in endodontic therapy. Oral Surg 1983;55:307-312.

Fuss Z, Weiss E l, Shalhav M. Antibacterial activity of calcium hydroxide-containing endodontic sealers on Enterococcus faecalis in vitro. Int Endod J. 1997;30:397-402.

Gutmann J L. Adaptation of injected thermoplasticized gutta-percha in the absence of the dentinal smear layer. Int Endod J 1993;26:87-92.

Gutmann J L. Clinical, radiographic and histologic perspectives on success and failure in endodontics. Dental Clinics of North America 1992;36:379-93.

Haapasalo M, Orstavik D. In vitro infection and disinfections of dentinal tubules. J Dent Res 1987; 66:8: 1375-9.

Kakehashi S, Stanley H R, Fitzgerald R J. The effect of surgical exposures of dental pulps in germ-free and conventional laboratory rats. Oral Surg 1965;20: 340-9.

Knappwost A. Das Depotophorese-Verfahren mit Kupfer-Calciumhydroid, die zur systematischen ausheilung fuhrende alternative in dir endodontie. ZWR der Zahnarzt 1993, 618-. Knappwost's method

Nerwich A., Figdor D., Endo D., and Messer H. H., pH changes in root dentin over a four week period following root canal dressing with calcium hydroxide. Journal of Endodontics 1993. 19:302-306.

Saunders W P, Saunders E M. Coronal leakage as a cause of failure in root-canal therapy: a review. Endod Dent Traumatol 1994;10:105-8.

Shalhav M, Fuss Z, Weiss I E. In vitro antibacterial activity of a glass ionomer endodontic sealer. J. Endodon 1997;23:616-619.

Siqueira J F, Uzeda M. Disinfection by calcium hydroxide pastes of dentinal tubules infected with two obligate and one faculative anaerobic bacteria. J Endodon 1996;22:674-6.

Sjogren U, Hagglund B, Sundqvist G, Wing K. Factors affecting the long-term results of endodontic treatment. J Endod 1990;16:498-504.

Spangberg L S W (1982): Endodontic medicaments. In: Biocompatibility of Dental Materials, D. C. Smith and D. F. Williams, Eds., Boca Raton: CRC Press, pp. 223-257.

Sundqvist G K. Ecology of the root canal flora. J Endodon 1992;18:427-430.

Swanson K, Madison S An evaluation of coronal microleakage in endodontically treated teeth. Part I. Time periods. J. Endod 1987;13:56-9.

van Amerongen W E, Rahimtoola S. Is ART really atraumatic? Community Dent Oral Epidemiol 1999;27:431-435.

Weiss E, Shalhav M, Fuss Z. Assessment of antibacterial activity of endodontic sealers by a direct contact test. Endod Dent Traumatol 1996; 12:179-184.

What is claimed is:

1. A method of treatment by preparing the space in need of treatment; and mobilizing products selectively into the space in need of treatment.

2. The method according to claim 1, wherein said preparing step further includes mechanically preparing the space.

3. The method according to claim 2, wherein said preparing step further includes insulating, sealing or isolating the treatment site to prevent the escape of electric current.

4. A method of treatment according to claim 3, wherein treatment site is a root canal space, said insulating or sealing step being further defined as insulating or sealing the apex of the tooth.

5. The method according to claim 1, wherein said mobilizing step further includes mobilizing charged molecules into the space in need of treatment or mobilizing multiple molecules having different charges into the space in need of treatment.

6. The method according to claim 1, wherein said method used is for treatments selected from the group consisting essentially of root canal treatment, cavity filling, root surface sensitivity, implant failure and atraumatic restorative treatment.

7. The method according to claim 1, wherein said mobilizing step further includes inserting first electrode into the root canal space and locating second electrode outside the tooth.

8. The method according to claim 8, wherein said first electrode is partially coated with an insulating material.

9. A method of treatment according to the claim 6, wherein said mobilizing step further includes mobilizing a second product into the space in need of treatment.

10. The method according to claim 6, wherein said mobilizing step further includes the step of mobilizing the materials via a low current electric field created by the electrodes.

11. The method according to claim 1, wherein said mobilizing step further includes mobilizing medicaments into otherwise inaccessible colonized or infected sites selected from the group consisting essentially of deep periodontal pockets, dental implants, orthopedic inserts, and artificial joints.

12. A tool for dental treatment, said tool comprising mobilizing means for actively moving a deposit site to an oral treatment site.

13. The tool according to claim 13, wherein said mobilizing means includes a first electrode inserted at the treatment site and at least one second electrode inserted outside of the treatment site creating an electric field for moving the product into the treatment site.
